(19) United States
(12) Patent Application Publication
(10) Pub. No.: US 2006/0067475 A1
(43) Pub. Date: Mar. 30, 2006

(54) Safety device for an imaging medical apparatus

(76) Inventors: Thomas Bauch, Munich (DE); Anke Weissenborn, Munich (DE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/231,365

(22) Filed: Sep. 20, 2005

Related U.S. Application Data
(60) Provisional application No. 60/617,615, filed on Oct. 8, 2004.

(30) Foreign Application Priority Data
Sep. 21, 2004 (EP) 04022385.1

(51) Int. Cl. H05G 1/54

(52) U.S. Cl. 378/117

(57) ABSTRACT

A safety device for an imaging medical apparatus comprising a patient entrance, in particular for a computer tomograph, a nuclear spin tomograph, a PET apparatus or a mobile x-ray apparatus such as for example a C-arc or a fluoroscope, wherein a proximity or contact detector is arranged in the area of the patient entrance. Furthermore, a braking device for a system comprising such an imaging medical apparatus and a patient carrier, which can be moved relative to each other, and to correspondingly equipped imaging medical apparatus.

### RELATED APPLICATION DATA

This application claims priority of U.S. Provisional Application No. 60/617,615 filed on Oct. 8, 2004, which is incorporated herein by reference in its entirety.

### FIELD OF THE INVENTION

The invention relates to a safety device for an imaging medical apparatus, such as a computer tomograph, a nuclear spin tomograph, a PET apparatus or a mobile x-ray apparatus (e.g., a C-arc/fluoroscope). More specifically, the invention relates to a braking device for a system including such an imaging medical apparatus and a patient carrier, and to such apparatus and systems that include safety devices or braking devices.

### BACKGROUND OF THE INVENTION

Imaging medical apparatus that can be used in accordance with the present invention are sometimes provided as mobile apparatus that can be moved over a patient carrier on which a patient is lying. Alternatively, there are imaging medical apparatus into which a patient carrier, including the patient lying on the carrier, can be moved. In both cases, there is a relative movement between the patient carrier (the patient) and the casing of the apparatus, which also will be referred to herein as the “gantry”.

Such gantries include an entrance for the patient carrier and the patient lying on the patient carrier. In most cases, this patient entrance has the form of a round opening on one side of the gantry.

Contact brakes for mobile gantries in the foot area are known in the art. Such brakes stop or otherwise inhibit the gantry's sliding or traveling movement when the gantry itself abuts a resistance in the foot area. However, safety devices for the patient entrance of the gantry have not been considered hitherto.

It is the object of the present invention to provide a safety device for an imaging medical apparatus which enables the apparatus to be secured in the area of the patient entrance.

### SUMMARY OF THE INVENTION

In accordance with the invention, a proximity or contact detector is arranged in the area of the patient entrance. Using the detector, it is possible to ascertain whether there is an undesirable proximity or contact in the area of the patient entrance, e.g., where there are sensitive parts of the imaging medical apparatus. If there is such a proximity or contact, appropriate measures then can be taken in order to avoid damage or incorrect handling.

In a preferred embodiment of the safety device, the detection range of the proximity or contact detector is in the plane of the patient entrance and/or at least partially protrudes out of said plane. Proximity or contact can therefore be detected before there is any actual contact with the gantry in the area of the entrance.

In accordance with another embodiment of the safety device, the detector is arranged completely and/or annularly or in sections around the patient entrance. Such an arrangement ensures appropriate level of safety at any point in or near the patient entrance.

Furthermore, the invention relates to a braking device for a system including an imaging medical apparatus, such as a computer tomograph or a nuclear spin tomograph, and a patient carrier. The patient carrier and imaging medical apparatus can be moved relative to each other such that a patient can be moved into the patient entrance of the imaging medical apparatus. The braking device includes a safety device such as has been described above in various embodiments, wherein in the event of an undesirable contact or proximity (e.g., contact or near contact) by the patient or patient carrier with the imaging medical apparatus, the proximity or contact detector generates a braking signal which brakes the relative movement between the imaging medical apparatus and the patient carrier via a brake. In this way, collision damage to the imaging medical apparatus and the patient carrier can be avoided, as well as injury to the patient. If the system includes a mobile medical apparatus, the medical apparatus can be braked. If the system includes a mobile patient carrier, the patient carrier can be braked.

Furthermore, the invention also relates to an imaging medical apparatus, such as a computer tomograph, a nuclear spin tomograph, a PET apparatus or a mobile x-ray apparatus (e.g., a C-arc or a fluoroscope), including a safety device such as has been described above.

In addition, the invention relates to a system including an imaging medical apparatus, such as a computer tomograph, a nuclear spin tomograph, a PET apparatus or a mobile x-ray apparatus (e.g., a C-arc or a fluoroscope), and a patient carrier, wherein the system includes a braking device such as has been described above.

In the following, the invention is explained in more detail on the basis of the enclosed drawings. The invention can include any of the features described herein, individually or in any combination.

### BRIEF DESCRIPTION OF THE DRAWINGS

FIG. 1 is a schematic front view of a CT gantry including a safety device in accordance with the invention.

FIG. 2 is a schematic lateral view of a gantry/patient carrier system including a safety device in accordance with the present invention.

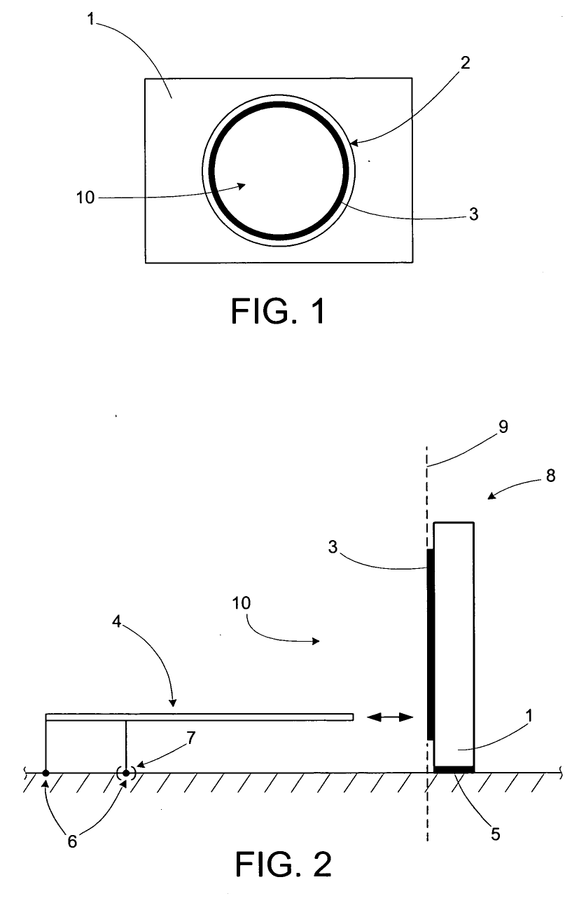

### DETAILED DESCRIPTION

The computer tomograph gantry shown in the figures has the reference numeral 1 and is only shown schematically. The gantry 1 includes the patient entrance 2, which is shown in the exemplary embodiment as a circular opening. Beyond the patient entrance 2 are the image recording elements (not shown) of the computer tomograph.

A contact detector ring 3 is attached around the circular opening of the patient entrance 2, and is displaced slightly inwards. As can be seen in FIG. 2, the contact detector ring 3 also protrudes outward from the gantry 1. The contact detector ring 3 can be any conventional contact detecting device known in the art. Consequently, further detail with respect to the contact detector ring 3 is not provided herein.

In operation, if an object makes contact with the contact detector ring 3, the detector ring 3 can emit a signal (e.g., an analog signal proportional to a level of contact and/or a digital signal that simply indicates contact) that can be used in various ways in a manner relevant to safety. As will be appreciated, the sensitivity of the contact detector ring 3 may be adjusted so as to not trigger a braking signal if a force and/or amount of contact between the object and the contact detector ring 3 is below a user setable threshold.

The aforementioned signal, for example, can trigger a braking process, i.e., a relative movement between the gantry 1 and a patient carrier 4 can be stopped or inhibited. For example, if the patient carrier 4 or the patient lying on the patient carrier 4 abuts the contact detector ring 3, a signal can be generated that triggers the braking process, which actuates a brake on the gantry 1 and/or the patient carrier 4.

Possible instances of the relative movement between the patient carrier 4 and the gantry 1 are shown in FIG. 2. The gantry 1, for example, can include a traveling/sliding mechanism 5, or the patient carrier 4 can include a traveling/sliding mechanism 6. Both mechanisms 5 and 6 can be of any type and are only shown schematically in FIG. 2, and one or both mechanisms can include a brake 7, such as a friction brake, for example. Such a brake can be operated via an electrical actuator, such as a solenoid or the like.

If the gantry 1 is the mobile component of the system 8, the contact detector 3 can relay the signal internally (via a wired or wireless signal connection) to the traveling mechanism 5 and/or to the brake (not shown) for the traveling mechanism 5, in order to initiate braking of the traveling mechanism. Alternatively, if the patient carrier 4 is the mobile of the system 8, the signal of the contact detector 3 can be transmitted via a wired or wireless connection to the traveling mechanism 6 and/or brake 7 for the patient carrier 4, in order to initiate braking of the patient carrier 4.

A proximity detector can be used in place of the contact detector ring 3. The proximity detector can include one or more proximity switches, light barriers (e.g., a light curtain), ultrasonic position detectors, infrared position detectors, or the like. Any type of known proximity detector can be used without departing from the scope of the invention. As an object approaches within a specified range of the proximity detector, the proximity detector can emit a signal (e.g., an analog signal proportional to the distance between the object and the proximity detector and/or a digital signal that simply indicates the object is within the specified distance of the proximity detector) that can be used in various ways in a manner relevant to safety. The distance between the object and the proximity detector in which a braking signal is triggered can be adjustable.

The detection range of the proximity or contact detector 3 can be in a plane 9 of the patient entrance 10 and/or at least partially protrudes out of said plane 9. Proximity or contact can therefore be detected before there is any actual contact with the gantry 1 in the area of the entrance 10.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An imaging medical apparatus equipped with a safety device, the imaging medical apparatus having a patient entrance and the safety device including a proximity or contact detector at the patient entrance.

2. The imaging medical apparatus as set forth in claim 1, wherein the imaging medical apparatus is a computer tomograph, a nuclear spin tomograph, a PET apparatus or a mobile x-ray apparatus.

3. The imaging medical apparatus as set firth in claim 2, wherein the mobile x-ray apparatus is a C-arc or a fluoroscope.

4. The imaging medical apparatus as set forth in claim 1, wherein the proximity or contact detector has a detection range in a plane of the patient entrance and/or at least partially protrudes out of said plane.

5. The imaging medical apparatus as set forth in claim 1, wherein the detector is arranged around the patient entrance.

6. A system comprising an imaging medical apparatus and a patient carrier, wherein the imaging medical apparatus and the patient carrier are capable of being moved relative to each other such that a patient can be moved into a patient entrance of the imaging medical apparatus, comprising;
a braking device, said braking device including a brake for inhibiting the relative movement between the imaging medical apparatus and the patient carrier; and
a proximity or contact detector operatively coupled to the brake, said detector being disposed at the patient entrance such that when an object comes within a specified proximity or contacts the detector, the detector provides a braking signal to the brake that inhibits the relative movement between the imaging medical apparatus and the patient carrier.

7. The system as set forth in claim 6, wherein the imaging medical apparatus is a computer tomograph, a nuclear spin tomograph, a PET apparatus or a mobile x-ray apparatus.

8. The system as set forth in claim 7, wherein the mobile x-ray apparatus is a C-arc or a fluoroscope.

9. The system as set forth in claim 6, wherein the system comprises a mobile medical apparatus and the brake operates to inhibit movement of the medical apparatus.

10. The system as set forth in claim 6, wherein the system comprises a mobile patient carrier, and the brake operates to inhibit movement of the carrier.

11. The system as set forth in claim 6, wherein the proximity or contact detector communicates to the brake via a wireless connection.

12. The system as set forth in claim 6, wherein the detector provides a signal to the brake that is proportional to a level of contact and/or a distance between the object and the detector.

13. A method for protecting against collision between a medical imaging device and a carrier for a patient, wherein the medical imaging device and carrier are relatively moveable, the method comprising outfitting the medical imaging device with a proximity or contact detector at an entrance of the medical imaging device, wherein the detector is operative to detect an imminent collision between the medical imaging device and the carrier and provides an output signal that causes relative movement between the imaging device and the carrier to be inhibited.
